(19) United States
(12) Patent Application Publication
(10) Pub. No.: US 2019/0026336 A1
(43) Pub. Date: Jan. 24, 2019

(54) Retrieving data from a data storage system

(71) Applicant: Vitesse Data, Inc., Redwood City, CA (US)

(72) Inventor: Feng Tian, Fremont, CA (US)

(73) Assignee: Vitesse Data, Inc., Redwood City, CA (US)

(21) Appl. No.: 16/042,621

(22) Filed: Jul. 23, 2018

Related U.S. Application Data
(60) Provisional application No. 62/536,350, filed on Jul. 24, 2017.

(51) Int. Cl. G06F 17/30; G06F 8/30

(52) U.S. Cl. CPC G06F 17/30463; G06F 17/30477; G06F 17/30595; G06F 17/30404; G06F 8/313; G06F 17/30427

(57) ABSTRACT

In an example method, a computer system receives a query for data stored in a relational database management system. The query includes one or more first functions of a first programming language, and one or more second functions specifying computer code of a second programming language different from the first programming language. The computer system generates a logical query plan based on the query, including one or more first logical nodes corresponding to the one or more first functions, and one or more second logical nodes corresponding to the one or more second functions in an interconnected logical tree. The computer system generates a physical execution plan based on the logical query plan, and executes the physical execution plan to retrieve the data stored in the relational database management system.

### CROSS-REFERENCE TO RELATED APPLICATION

This application claims priority from U.S. Provisional Application Ser. No. 62/536,350, filed on Jul. 24, 2017, which is incorporated herein by reference in its entirety.

### TECHNICAL FIELD

The disclosure relates to computerized data storage systems.

### BACKGROUND

Computers can store, access, and/or modify data using a data storage system, such as a computerized database. As an example, computers can store data within a database, such that the data is recorded and retained for further use. As another example, computers can process, manipulate, or otherwise modify data stored within the database to produce useful or meaningful information from the data. As another example, computers can retrieve a copy of data from the database.

A database is an organized collection of data. In some cases, a database can represent data using a collection of schemas, tables, queries, reports, views, and/or other computer objects.

A database management system (DBMS) is a computer software application that interacts with the user, other applications, and the database itself to capture and analyze data. In some cases, a DBMS can be designed to enable the definition, creation, querying, update, and administration of databases. Example DMBSs include MySQL, PostgreSQL, MongoDB, MariaDB, Microsoft SQL Server, Oracle, Sybase, SAP HANA, MemSQL, SQLite, and IBM DB2.

A relational database management system (RDBMS) is a DBMS that is based on a relational model, or an approximation of a relational model. For instance, data can be represented in terms of tuples, grouped into relations. A database organized in terms of the relational model is a relational database. The relational model provides a declarative method for specifying data and queries. For example, users can directly state what information the database contains and what information they want from it, and let the database management system software take care of describing data structures for storing the data and retrieval procedures for answering queries. Example RDBMSs include Oracle, MySQL, Microsoft SQL Server, PostgreSQL, IBM DB2, Microsoft Access, and SQLite.

In some cases, a relational database can use the Structured Query Language (SQL) data definition and query language. In an SQL database schema, a table corresponds to a predicate variable. Further, the contents of a table correspond to a relation. Further still, key constraints, other constraints, and SQL queries correspond to predicates.

### SUMMARY

As described herein, a transducer can be embedded in a RDBMS to execute code with respect to data stored in the RDBMS. In some cases, a transducer can be used to extend the capabilities of the RDBMS. For instance, a transducer can be used to execute code of a programming language different from the programming language native to the RDBMS. As an example, a RDBMS can natively execute code written in a declarative programming language (e.g., SQL), and the transducer can be used to enable execute code of a different language, such as an imperative programming language (e.g., C++, Java, Ruby, C#, Python, Go, Lips, Haskell, Lips, Haskell, OCaml, and/or F#).

In some cases, the transducer enables the execution engine to seamlessly execute code written in multiple different programming languages. As an example, the transducer can enable users to selectively develop code in a first programming language to perform certain tasks, and selectively develop code in a second programming language to perform certain other tasks. The code can be executed together in a seamless manner, without requiring that the user operate multiple different systems and/or workflows for each programing language.

The transducer provides various technical benefits. As an example, the transducer can extend the capabilities of the RDBMS. For instance, the transducer enables an RDBMS to execute code written according to multiple different programming languages. Thus, the transducer can improve the capabilities of the RDBMS, such that it can be more efficiently used in a variety of different contexts. Further technical benefits are described herein.

In an aspect, a method includes receiving, at a computer system, a query for data stored in a relational database management system. The query includes one or more first functions of a first programming language, and one or more second functions specifying computer code of a second programming language different from the first programming language. The method also includes generating, using the computer system, a logical query plan based on the query. Generating the logical query plan includes generating one or more first logical nodes corresponding to the one or more first functions. The one or more first logical nodes represent relational operators defined by the one or more first functions. Generating the logical query also includes generating one or more second logical nodes corresponding to the one or more second functions. The one or more second logical nodes represent operations defined by the computer code of a second programming language. Generating the logical query also includes generating the logical query plan comprising a logical tree representing the query. The logical tree includes the one or more first logical nodes interconnected with the one more second logical nodes. Each interconnection represents an exchange of intermediate data between nodes. The method also includes generating, using the computer system, a physical execution plan based on the logical query plan, and executing the physical execution plan to retrieve the data stored in the relational database management system.

Implementations of this aspect can include one or more of the following features.

In some implementations, the first programming language can be a declarative programming language. The first programming language can be Structured Query Language (SQL).

In some implementations, the second programming language can be an imperative programming language. The second programming language can be one of C, C++, Java, Scala, Python, Perl, Go, R, Lisp, or F#.

In some implementations, each second function can include a code sub-function specifying the computer code of the second programming language, an input sub-function specifying input data for the computer code of the second programming language, and an output sub-function specifying output data resulting from an execution of the computer code with respect to the input data.

In some implementations, generating the logical query plan can include generating a plurality of candidate logical trees representing the query, selecting one of the plurality of candidate logical trees based on one or more optimization criteria, and including the selected candidate logical tree in the logical query plan.

In some implementations, the one or more optimization criteria can include at least one of a data size of the data stored in the relational database management system, an arrangement of the data stored in the relational database management system, or an estimated resource cost associated with retrieving the data stored in the relational database management system.

In some implementations, the one or more optimization criteria can include an estimated resource cost associated with executing the computer code of the second programming language.

Other aspects are directed to systems, devices, and non-transitory, computer-readable mediums for performing the functions described herein.

The details of one or more embodiments are set forth in the accompanying drawings and the description below. Other features and advantages will be apparent from the description and drawings, and from the claims.

### DESCRIPTION OF DRAWINGS

FIG. 1 is a block diagram of a system that stores, retrieves, and modifies data.

FIG. 2 is a flow chart diagram of an example process for executing a query in an RDBMS.

FIG. 3 is a diagram of an example logical tree of a logical query plan.

FIG. 4 is a diagram of another example logical tree of a logical query plan.

FIG. 5 is a diagram of an example computer system

### DETAILED DESCRIPTION

A transducer is a component that receives one sequence of input and produces a different sequence of output based on the sequence of input. In some cases, a transducer can produce a single output based on a single corresponding input (e.g., a current input value). In some cases, a transducer can accumulate input data over a period of time (e.g., obtain a sequence of multiple inputs), and generate one or more outputs based on the inputs. A transducer can be used in a variety of contexts, such as to produce useful or meaningful information from data.

As described herein, a transducer can be embedded in a RDBMS to execute code with respect to data stored in the RDBMS. In some cases, a transducer can be used to extend the capabilities of the RDBMS. For instance, a transducer can be used to execute code of a programming language different from the programming language native to the RDBMS.

As an example, a RDBMS can natively execute code written in a declarative programming language. A declarative programming language is a language having a style that expresses the logic of a computation without describing its control flow. From a practical perspective, a declarative programming language focuses on what the program should accomplish without specifying how the program should achieve the result. For instance, using a declarative programming language, users can directly state what information the database contains and what information they want from it. In response, the RDBMS parses the user's instructions, and handles the describing of data structures for storing the data and the retrieval procedures for answering queries. Example declarative programming languages include SQL, Query By Example (QBE), and Pig Latin, among others.

However, the transducer can be used to enable execute code of a different language, such as an imperative programming language (also referred to a “procedural” programming language or a “functional” programming language), within the execution engine. An imperative programming language is a language that uses statements that changes a program's state and/or defines a control flow. From a practical perspective, an imperative programming language focuses on describing how a program operates. For instance, using an imperative programing language, a user can directly state the specific procedures, functions, arguments, and/or parameters for performing a particular task. In response, the RDBMS parses the user's instructions, and executes them as specified. Example imperative programming languages include C++, Java, Ruby, C#, Python, Go, Lips, Haskell, Lips, Haskell, OCaml, and F#, among others.

Programming languages need not be solely declarative or solely imperative, and can instead include characteristics of both. As an example, Scala is a programming language that includes characteristics of both an imperative programming language and a declarative programming language.

In some cases, the transducer enables the execution engine to seamlessly execute code written in multiple different programming languages. As an example, the transducer can enable users to selectively develop code in a first programming language to perform certain tasks, and selectively develop code in a second programming language to perform certain other tasks. The code can be executed together in a seamless manner, without requiring that the user operate multiple different systems and/or workflows for each programing language.

The transducer provides various technical benefits. In some cases, the transducer extends the capabilities of the RDBMS. For instance, declarative programming languages, such as SQL, rely on the use of relational algebra or equivalently first order logic. Relational algebra is often a good fit for certain types of workloads (e.g., identifying records of interest in a database through the use of first order queries). However, relational algebra may be less suitable for applications such as graph data, streaming events data, deep learning, as queries used in such applications are often difficult to express using relational algebra. Further, an RDBMS often executes such queries inefficiently.

In contrast, imperative programming languages are often more suitable in contexts where declarative programming languages are not. For example, under some circumstances, it may be easier for users to develop code using imperative programming languages to achieve a particular desired result. Further, code written according to an imperative programming language are often executed more efficiently by a computer system, thereby improving performance.

The transducer enables an RDBMS to execute code written according to multiple different programming languages. Thus, the transducer can improve the capabilities of the RDBMS, such that it can be more efficiently used in a variety of different contexts. Further, the performance of the RDBMS is enhanced.

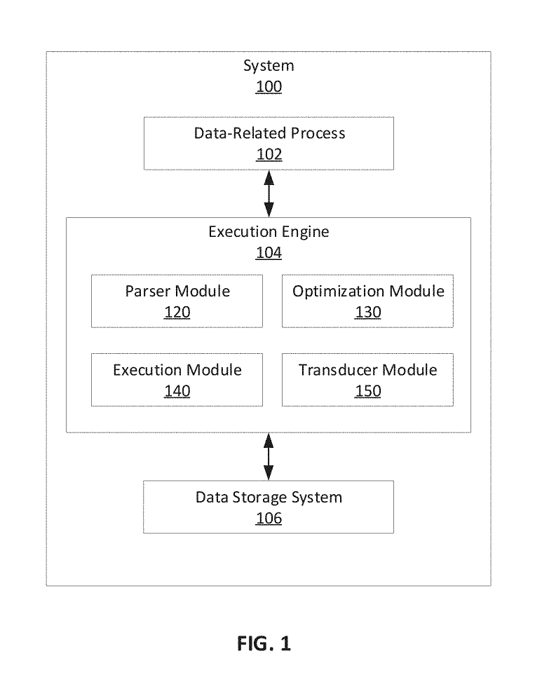

FIG. 1 is a block diagram of a system 100 that stores, retrieves, and modifies data. The system 100 includes one or more data-related processes 102 (e.g., computer programs or portions of computer programs executing on the system), an execution engine 104, and one or more data storage systems 106.

In an example implementation, a user interacts with the system 100 (e.g., through an appropriate user interface) to create, delete, and modify data. When a user wishes to store particular data (e.g., to retain certain data for later retrieval), a data-related process 102 transmits a request with the data to an execution engine 104. In turn, the execution engine interprets and executes the request, and transmits the data to the data storage system 106 for storage (e.g., within one or more physical storage devices or logical units).

As another example, when a user wishes to retrieve particular data, a data-related process 102 transmits a request for the data to the execution engine 104. The execution engine 104 interprets the request, retrieves the requested data from the data storage system 106, and makes the data available to the data-related process 102.

As another example, when a user wishes to modify particular data, a data-related process 102 transmits a request and the modified data to the execution engine 104. The execution engine 104 interprets the request and executes the request, and transmits the modified data to the data storage system 106 for storage.

Various components of the system 100 can be interconnected such that they can each transmit data to and receive data from other interconnected components. For example, some components of the system 100 can be connected such that the data-related processes 102 can communicate with the execution engine 104, such that the execution engine 104 can communicate with the data storage system 106. The interconnection of components can be implemented in a variety of ways. In some implementations, some components can be directly connected to other components, for example through a serial bus connection, system bus, or other direct connection. In some implementations, some components of the system 100 can be interconnected through a local area network (LAN), through a wide area network (WAN), such as the Internet, or through a Storage Area Network (SAN), such as a Fibre Channel network, an iSCSI network, an ATA over an Ethernet network, or a HyperSCSI network. Other types of networks can also be used, for instance a telephone network (cellular and/or wired), a Wi-Fi network, Bluetooth network, near field communications (NFC) network, or other network capable of transmitting data between interconnected systems. In some implementations, two or more networks may be interconnected, such that components connected to one network can communicate with devices connected to another network. In some implementations, some components can be directly connected to other components, for example through a serial bus connection or other direct connection. In some implementations, one or more of the components (e.g., the data storage system 106) can be managed by a cloud storage interface. In an example, data storage system 106 can be distributed over one or more networks, and the cloud storage interface can manage data-related requests to and from the execution engine 104.

In some implementations, users can interact with the system 100 through an appropriate user interface to directly or indirectly process data. As examples, the system 100 can be a client computing device, such as a desktop computer, laptop, personal data assistant (PDA), smartphone, tablet computer, or any other computing device that allows a user to view or interact with data. In some implementations, the system 100 does not directly interact with users, and instead indirectly receives instructions and data from users through an intermediary system. As examples, the system 100 can be a computing device such as server computer that indirectly receives instructions and data from users via one or more client computing devices. In some implementations, the system 100 need not receive instructions and data from users at all. For example, in some cases, the system 100 can be automated, such that it creates, deletes, and modifies data without substantial input from a user.

The data-related processes 102 are computerized processes that create, store, access, and/or modify data. As an example, data-related processes 102 can be one or more instances of executable instructions (e.g., a computer program) that perform particular tasks that create, store, access, and/or modify data. Data-related processes 102 can be implemented on various types of components. For example, in some implementations, data-related processes 102 can be implemented on a processing apparatus (e.g., a computer processor) that executes a collection of instructions stored on a data storage device (e.g., memory, a physical storage device, and so forth). When executed, these instructions can perform data processing tasks. In some implementations, data-related processes 102 can be a sub-process of a broader application (e.g., a computer program) that performs additional functions other than creating, storing, accessing, and/or modifying data. As an example, in some implementations, data-related processes 102 can be implemented as a part of an operating system kernel.

The execution engine 104 is a component that parses and interprets request from the data-related processes 102, optimizes the request, and executes the request to store, access, and/or modify data stored on the data storage system 106. For example, the execution engine 104 can receive a request having one or more queries or commands, interpret the commands or queries to ascertain their meaning, optimize the request such that it can be more efficiently and/or effectively executed, and execute the commands or queries to fulfill the request. The execution engine 104 can include various subcomponents, such as a parser module 120, an optimization module 130, and an execution module 140 to perform each of these tasks. The execution engine 104 can include one or more transducer modules 150 to provide additional functionality and/or modify the functionality of the execution engine 104.

In some cases, the execution engine 104 can also manage the storage and retrieval of information in a format that can be readily understood by one or more computer systems. For instance, the execution engine 104 can include both a specification of the manner in which data is to be arranged in data storage (e.g., on storage media), and also utilities that enable operations to be performed on the data, e.g., reading and writing of data. As an example, the execution engine 104 can include one or more computerized processes or components that control how data is stored and retrieved from one or more data storage systems 106. For instance, an execution engine 104 can control how data is stored and retrieved from physical storage devices such as disk accessing storage devices (e.g., hard disk drives), non-volatile random access memory (RAM) devices, volatile RAM devices, flash memory devices, tape drives, memory cards, or any other devices capable of retaining information for future retrieval. As another example, the execution engine 104 can include one or more computerized processes or components that control how data is stored and retrieved from one or more logical units of the data storage system 106 (e.g., one or more logical units that have been mapped from one or more physical storage devices or other logical units).

In some cases, the system 100 can be a RDBMS. For example, the system 100 can store data in a relational database (e.g., a database that represents data in terms of tuples, grouped into relations). Further, the data-related processes 102 can be computerized processes that accesses data based on queries (e.g., a portion of code specifying a request for information) represented by code written in a declarative programming language (e.g., SQL).

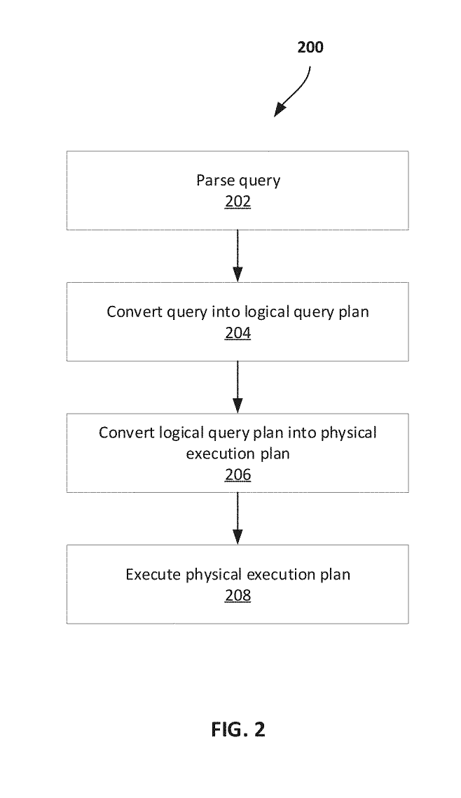

FIG. 2 shows an example process 200 for executing a query in an RDBMS. The process 200 can be performed, for example, using the system 100 to process queries to retrieve data from the system 100.

The system 100 parses the query (step 202). As an example, a query can be represented by code, and written according to plain text (e.g., including one or more commands written using alphanumeric characteristics and/or symbols). The system 100 can parse the code (e.g., using the parser module 120) to determine the presence and relationship between each of the commands represented by the code. As an example, a query can be represented by code written in SQL. Example SQL commands that can be included in an query include SELECT (e.g., to extract data from a database), UPDATE (e.g., to update data in a database), DELETE (e.g., to delete data from a database), INSERT INTO (e.g., to insert new data into a database), CREATE DATABASE, (e.g., to create a new database), ALTER DATABASE (e.g., to modify a database), CREATE TABLE (e.g., to create a new table), ALTER TABLE (e.g., to modify a table), DROP TABLE (e.g., to delete a table), CREATE INDEX (e.g., to create an index or search key), and DROP INDEX (e.g., to delete an index), among others.

The system 100 converts the query into a logical query plan for retrieving the requested data from the system 100 (step 204). This can be performed for example, using the parser module 120. A logical query plan is a set of information describing one or more relational algebra operations that can be performed to fulfill the query. Example relational algebra operations include union (∪), intersection (∩), difference (−), selection (σ), projection (π), join ( [symbol] ), duplicate elimination (δ), grouping and aggregation (γ), sorting (τ), and rename (φ, among others.

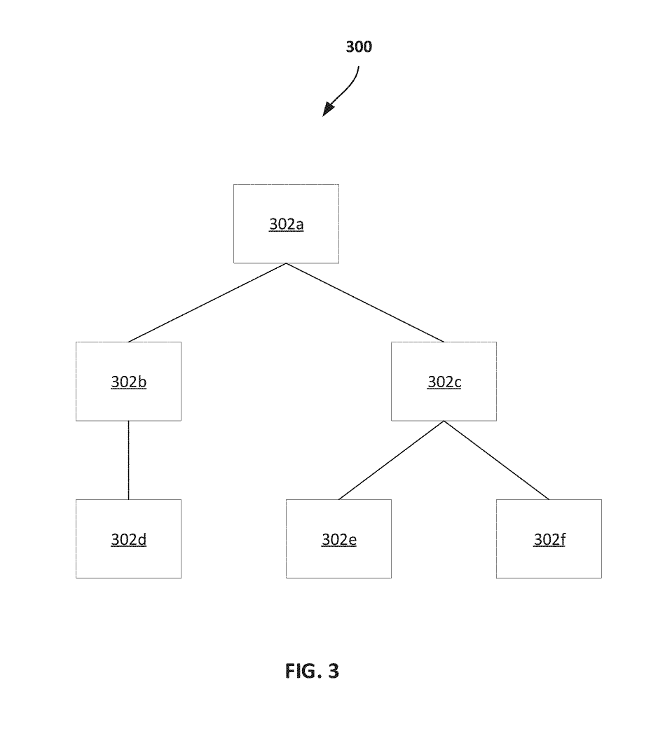

In some cases, the logical query plan can be represented as a logical tree with two or more interconnected logical nodes. As an example, a simplified logical tree 300 is shown in FIG. 3. The logical tree 300 includes several logical nodes 302, each representing a different relational algebra operation that is performed to fulfill the query.

Further, a logical tree can indicate an order with which different relational algebra operations are performed, and the relational between the input and output of each relational algebra operation. For instance, operations corresponding to the logical nodes can be executed in a tiered manner. For example, operations corresponding to the logical nodes in a lowest tier of the logical tree can be executed first, followed the operations corresponding to the logical nodes in the next higher tier, and so forth until all of the operations have been executed. Further, the output from one operation can be used as an input of another operation, such that data is successively manipulated over multiple different operations. This can be represented, for example, by interconnections between the logical nodes, each representing the exchange of intermediate data between those logical nodes.

As an example, as shown in FIG. 3, the logical tree 300 includes a logical node 302a positioned with respect to a first tier (e.g., a top tier), logical nodes 302b and 302c positioned with respect to a second tier and logical nodes 302d-f positioned with respect to a third tier (e.g., a bottom tier). The operations corresponding to each of the logical nodes 302d-f (e.g., in the third tier) are executed first, followed by the operations corresponding to each of the logical nodes 302b and 302c (e.g., in the second tier), followed by the operation corresponding to the logical node 302a (e.g., in the first tier). Further, the output of the logical node 302d is used as an input in the logical node 302b (indicated by a connection line). Similarly, the output of the logical nodes 302e and 302f are used as inputs in the logical node 302c. Similarly, the output of the logical nodes 302b and 302c are used as inputs in the logical node 302a.

Although an example logical tree 300 is shown in FIG. 3, it is understood that this is merely an illustrative example. In practice, a logical tree can include any number of logical nodes, arranged according to any number of tiers, and interconnected by any number of different ways.

The system 100 converts the logical query plan into a physical execution plan for retrieving the requested data from the system 100 (step 206). This can be performed for example, using the parser module 120. A physical execution plan is a set of information describing how to perform the one or more relational algebra operations used in the logical query plan. In some cases, the physical execution plan can be similar to the logical query plan (e.g., include an arrangement of relational algebra operations in a logical tree), and also additionally include information regarding how data can be provided to each logical node of the logical tree. For example, the physical execution plan can include information describing the location of data to be used as inputs with respect to one or more of the logical nodes (e.g., an access path, a file scan, or an index for the data). As another example, the physical execution plan can include information describing how each operation can be implemented (e.g., a specific computer process, technique, or algorithm to be used to perform the operation). As another example, the physical execution plan can include scheduling information describing the time at which the operations are executed.

The system 100 subsequently executes the physical execution plan to retrieving the requested data from the system 100 (step 208). This can be performed for example, using the execution module 140. In some cases, the requested data can be returned to a data-related process directly (e.g., a copy of the requested data can be transmitted to the data-related process for use). In some case, the requested data can be stored in a separate location, and the location of the requested data can be transmitted to a data-related process.

As described herein, a transducer can be embedded in a RDBMS to execute code with respect to data stored in the RDBMS. In some cases, a transducer can be used to extend the capabilities of the RDBMS. For instance, a transducer can be used to execute code of a programming language different from the programming language native to the RDBMS.

As an example, as shown in FIG. 1, the execution engine 104 includes a transducer module 150. The transducer module 150 can be configured to parse, interpret, and/or execute code written in one or more programming languages other than the programming language native to the execution engine 104 (e.g., native to the parser module 120). For example, in some cases, the execution engine 104 can be configured to natively handle code written in a declarative programming language (e.g., SQL) using the parser module 120, while the transducer module 150 can be configured to handle code written in an imperative programming language (e.g., Python). Thus, the execution engine 104 can execute code of two or more different programming language using the transducer module 150.

In some cases, the execution engine 104 can convert a query into a logical query plan using the parser module 120. For instance, the parser module 120 can generate a logical tree representing the query, and populate the logical tree with one or more interconnected logical nodes representing one or more operations that can be performed to fulfill the query. In some cases, the logical tree can include one or more logical nodes corresponding to commands written in a programming language native to the execution engine 104 (e.g., SQL). Further, the logical tree can include one or more logical nodes corresponding to commands written in a different programming language that can be parsed, interpreted, and executed by the transducer module 150 (e.g., Python). As an example, referring to FIG. 3, one or more of the logical nodes 302a-f can correspond to commands written in a programming language native to the execution engine 104 (e.g., native to the parser module 120), while one or more of the logical nodes 302a-f can correspond to command written in a different programming language that can be parsed, interpreted, and executed by the transducer module 150.

In some cases, the execution engine 104 can use the parser module 120 to parse a query received from a data-related process 102, and generate logical nodes for any commands that are written in a programming language native of the execution engine 104. Further, the execution engine 104 can selectively invoke, initiate, or call on the transducer module 150 when the parser module 120 encounters code written in a programming language not native to the execution engine 104. In some cases, the execution engine 104 selectively invoke, initiate, or call on the transducer module 150 when the parser module 120 encounters a command or function specifying that the transducer module 150 be used (e.g., a function or other command specific to the transducer module 150). In some cases, these commands or functions can be user-defined functions.

As a simplified example, a sequence of code is shown below:

```
SELECT Further_Processing
FROM (
SELECT Transducer_Outputs,
            Transducer(‘[transducer code]’),
            Transducer_inputs
            FROM SubQueryAsInput
) TransducerSubQuery
```

In this example, the code includes commands written in SQL (e.g., “SELECT” and “FROM”), and commands written in a second programming language (e.g., represented by “[transducer code]”). The commands written in the second programming language is specified by a sub-function (e.g., “Transducer”). Further, the inputs and outputs of the commands written in the second programming language are specified by respective sub-functions (e.g., “Transducer_Output” and “Transducer_inputs”).

When the query is provided to the execution engine 104 for execution, the execution engine 104 parses the code using the parser module 120, and identifies commands that are written in a program language native to the execution engine 104 (e.g., native to the parser module 120). In this example, SQL is native to the execution engine 104. Thus, the execution engine 104 will use the parser module 120 to generate a logical plan having one or more logical nodes representing those commands.

However, when the execution engine 104 encounters sub-functions specifying the commands written in the second programming language, and the outputs and input of those commands (e.g., “Transducer,” “Transducer_Output,” and “Transducer inputs”), the execution engine 104 invokes, initiates, or calls on the transducer module 150 to handle the code (“[transducer code]”). In turn, the transducer module 150 parses and interprets the commands written in a second programming language, and generates a logical node representing that code. In turn, the transducer module 150 provides the logical node to the execution engine 104 (e.g., to the parser module 120) for inclusion in the logical query plan.

In some cases, the commands written into the second programming language are represented by a particular logical node (e.g., a “transducer logical node”). Further, the inputs of the commands are represented by interconnections leading into the transducer logical node from another logical node, and represent how data is transmitted to the transducer logical node for processing. Further, the outputs of the commands are represented by interconnections leading from the transducer logical node to another logical node, and represent how data is transmitted from the transducer logical node for further processing.

The execution engine 104 continues parsing and interpreting the remaining code using the parser module 120 to add logical nodes in the logical tree of the logical query plan, selectively calling on the transducer module 150 as needed to interpret code of a non-native programming language. After the execution engine 104 uses the parser module 120 to generate a logical query plan, it generates a corresponding physical execution plan using the parser module 120, and executes the physical execution plan using the execution module 140.

A logical query plan can include logical nodes provided by the transducer module 150 (e.g., logical nodes corresponding to commands written in a programming language that is not native to the execution engine 104), embedded among other logical nodes (e.g., logical nodes corresponding to commands written in a programming language that is native to the execution engine 104). Thus, the logical query plan, when converted into a physical execution plan and executed by the execution engine 104, represents a seamless execution of commands of two or more different languages. As a result, the execution engine 104—which might otherwise be capability of interpreting an executing commands of a single programming language using the parser module 120—can seamlessly execute commands written according to multiple different programming languages. This enables a user to develop code using multiple different languages, and selectively use different programming languages depending on the needs of his application. As an example, in some cases, a user can use SQL commands to perform certain tasks, and use Python commands to perform certain other tasks. Each of those commands can be executed seamlessly together, without requiring that the user operate multiple different systems and/or workflows to execute the commands.

In some cases, a logical query plan can be “optimized” prior to being converted into a physical execution plan. This can be performed, for example, using the optimization module 130. As described herein, a logical query plan is a set of information describing one or more relational algebra operations that can be performed to fulfill the query. Due to the nature of declarative programming languages—which allow users to simply state what information the database contains and what information they want from it, without specifying how such tasks are performed—multiple different logical query plans could potentially represent the same query. For example, multiple different logical query plans, which converted into a physical execution plan and executed by the executing engine, might result in the same output, even if the specific steps and order of steps specified in the logical query plan may differ.

To improve the performance of the system, a logical query plan can be optimized, such that use of the logical query plan is faster and/or more efficient. In some cases, the optimization module 130 can generate multiple different candidate logical trees representing a particular query. The optimization module 130 can select one of the candidate logical trees to include in the logical query plan. In some cases, the optimization module 130 can make a selection based on factors or criteria such as a data size of the data stored in the relational database management system, an arrangement of the data stored in the relational database management system, or an estimated resource cost associated with retrieving the data stored in the relational database management system. In some cases, a logical tree can be selected based on an estimated resource cost associated with executing the code written in the programming language that is not native to the execution engine (e.g., the code that is parsed, interpreted, and executed by the transducer).

As an example, there may be many (e.g., millions) of different logical trees, if executed, that all produce the correct answer to a query. Optimization can be performed by choosing one such logical tree that has the minimal (or otherwise acceptably low) execution cost. To choose the tree, an optimization module can compute the estimated cost of executing each of these logical trees.

Statistics and ordering information can be used to compute the cost. Example statistics that can be used include, for example, the number of rows that is input to a particular logical node (e.g., a relational algebra operation), the histogram of input data, and available system resources to the system (e.g., available memory). A system can use this information to compute statistics for the output of the logical node (e.g., the number of rows, the histogram of output data, etc.). This information can be used to optimize other logical nodes that receive inputs from this logical node.

Partition and ordering information can also be useful during the optimization process. For example, if the optimization module knows that the input data is already sorted with respect to values in particular columns, the optimization module may choose an algorithm that takes advantage of this information. For example, if the optimization module knows that data is sorted into groups, aggregates of the data (e.g., sum, average, etc.) within a group can be executed group by group, without having to use a hash table to put data into groups.

In some cases, the transducer module 150 also can be used to optimize a logical query plan. For instance, the optimization module 130 can determine statistics of data to be input into a logical node corresponding to “transducer” code (e.g., code that is handled by the transducer module 150, rather than natively by the parser module 120). The transducer module 150 can used information in a similar manner as described above with respect to the optimization module.

As an example, the optimizer module can determine statistics for the input data to be input into the logical node corresponding to transducer code (e.g., the number or rows in the data, a histogram of the data, etc.), and call a function supplied by the transducer to supply this information to the transducer module. The transducer module can use this information to optimize the transducer code. For example, if the number of rows of the input is relatively small and fits in memory, the transducer module can use an in-memory sort algorithm, such as “quicksort.” But, if the number of rows is relatively large and cannot fit into memory, the transducer module can select an external merge sort instead.

Similarly, the transducer module can compute statistics regarding the data that is output from the logical node corresponding to the transducer code (e.g., the number or rows in output data, a histogram of the output data, etc.) and supply these back to optimization module as a return to the optimization module's call to the transducer module. In a similar manner as described above, the optimization module can continue to optimize the rest of the query using the returned information.

Although FIG. 1 shows the execution engine 104 having the parser module 120, optimization module 130, execution module 140, and transducer module 150 as sub-components, it is understood that this is an illustrative example. In practice, one or more of the modules can be implemented separately from the execution engine 104. As an example, in some cases, the transducer module 150 can be implemented separately from the execution engine 104, and the execution engine 104 can communicate with the transducer module 150 to provide the functionality described herein.

### First Example Application

An example application of a transducer with respect to historical stock prices is described below.

An example set of data stored in an RDBMS is shown in Table 1.

TABLE 1
Example set of data stored in an RDBMS.

| Stock Symbol | Day | Price |
|---|---|---|
| A | 1 | 1.05 |
| A | 2 | 1.07 |
| A | 3 | 1.11 |
| A | 4 | 1.02 |
| A | 5 | 1.09 |
| A | 6 | 1.13 |
| B | 1 | 22.3 |
| B | 2 | 20.1 |

Table 1 shows the historical price of two stocks “A” and “B” over a series of days. This can be referred to as “time series” data.

A user may wish to merge this time series data into “runs.” For instance, for each stock, a user may wish to find the range of days for which that stock continuously gained or lost value (e.g., a “run” of continuous gains or losses).

Referring to stock “A,” from day 1 to day 3, the stock had an ascending run from $1.05 to $1.11. Then from day 3 to day 4, the stock had a descending run from $1.11 to $1.02. Then from day 4 to day 6, the stock had another ascending run from $1.02 to $1.13.

It is relatively difficult to write an SQL for such a query. For instance, to decide if the stock's price at day N is greater than or less than the stock's price at the previous day, data from day N−1 would need to be known. Such an expression is difficult to express in a relational database. For example, using Online Analytical Processing (OLAP) window functions, SQL can be used to access data from a “previous row” in a table. However, there is no known upper limit of the length of a run. Thus, this is essentially out of the expressive power of relational algebra. Further, although a combination of a recursive query and a OLAP window function can express this query in theory, the result would be complex and inefficient, and may have little or more practical value.

However, such a query could be more efficiently implemented using a procedural program (e.g., a program written using an imperative programming language). For example, the price data of stock “A” can be fed into a relatively simple procedural program, and the program would merely need to keep track of the marker date that begins a run. Such a task is relatively simple to express in an imperative programming language (e.g., compared to developing a complex SQL query to perform the same task). Further, the code is comparative more efficient to execute. For instance, the code would have a linear running time, and have relatively constant memory consumption.

Example pseudo-code for invoking the transducer is provided below:

```
SELECT
            Tr_out(Symbol),
            Tr_out(Run_Start_Date), Tr_out(Run_Start_Price),
            Tr_out(Run_End_Date), Tr_out(Run_End_Price),
            Tr_SrcCode(‘
            // Source code to compute run (e.g., source code written
in a language other than SQL).
            ’)
            Tr_input(...)
FROM
            INPUT_DATA
```

Note that “INPUT_DATA” can by any SQL subquery. In general, in a “shared nothing” (SN) architecture, data can be partitioned in many computer nodes. Therefore, data is not necessarily partitioned by “Stock Symbol.” Further, for each “Stock Symbol,” the data is not necessarily in date order. Thus, we can write “INPUT_DATA” as:

SELECT row_number( ) OVER (PARTITION_BY Symbol
ORDER BY Date)
Symbol, Date, Price
FROM DATA

“OVER (PARTITION BY . . . ORDER BY . . . )” is a standard SQL OLAP window specification clause. It will enforce a constraint that the data input into the transducer is partitioned by “Stock Symbol” and ordered by date.

The results of the transducer can be further queried, for example, to find the average length of ascending runs of each stock. For example:

SELECT Symbol, AVG(end_date − start_date) -- compute
average length
FROM TRANSDUCER_SUBQUERY
WHERE end_price >= start_price -- we treat no change as ascending
GROUP BY Symbol

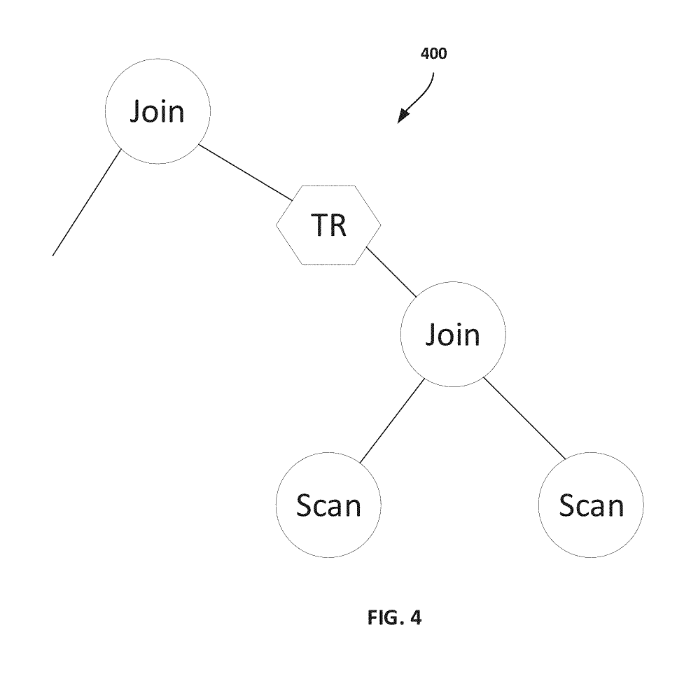

As shown in FIG. 4, the transducer code in the above SQL can be translated into a relation operator “TR” (e.g., a transducer logical node) and included in a logical tree 400 of a logical query plan among other relation operations “Join” and “Scan” (e.g., other logical nodes). Further, the logical query plan can be optimized. For example, an optimization module can first optimize the input the “TR” and deduce statistics of the input. If partition or ordering information is provided, the optimization module can notify the transducer of such constraints. The transducer can optimize its own code using this information, then provide stats regarding the optimized code to feed to optimization module. This information can be used by the optimization module to optimizing the remaining queries.

The transducer can also supply partition/order information back to the optimization module. For example, in this example, after computation runs, the data is still partitioned by “Stock Symbol,” and the output is ordered by start date. This mechanism of obtaining statistics into the transducer and feeding statistics back into the optimization module can be used to produce optimized, efficient plans.

In some cases, execution of the query can be parallel on multiple computer nodes. Data communications between the transducer node and the relational operators can be bounded (e.g., constant memory consumption) and deadlock free. Further, the transducer code can be JITed for increased performance. Further, the time complexity of the transducer implementation is O(n) (e.g., linear with respect to data) and space complexity is O(1) (e.g., constant). This is the theoretically optimal result.

Example code to perform the functions above is included below.

load.sql—This query will generate simulated stock price data and load the data into a table in database. The data will include information regarding four stocks (“S1,” “S2,” “S3,” “S4”), each stock having 200 days of price data (day 0 to day 199). Each stock has an 80% chance of gaining value on a trading day, and a 20% of losing on a trading day.

```
-- Example of PHI Transducer.
-- The following SQL will generate some simulated stock price data.
--
CREATE TABLE stock AS
select symbol, day, price from
(
select
--
-- Output columns
--
dg_utils.transducer_column_text(1) as symbol,
dg_utils.transducer_column_int4(2) as day,
dg_utils.transducer_column_float8(3) as price,
--
-- Transducer functions, $PHI$ is PostgreSQL dollar quoted string.
--
dg_utils.transducer($PHI$PhiExec go
// BEGIN INPUT TYPES
// i int32
// END INPUT TYPES
//
// BEGIN OUTPUT TYPES
// symbol string
// day int32
// price float64
// END OUTPUT TYPES
//
package main
import (
            “fmt”
            “math/rand”
)
func main( ) {
            for rec := NextInput( ); rec != nil; rec = NextInput( ) {
                i, _ := rec.Get_i( )
                symbol := fmt.Sprintf(“S%d”, i)
                p := 100.0
                for n:=0; n<200; n++ {
                    var outrec OutRecord
                    outrec.Set_symbol(symbol)
                    outrec.Set_day(int32(n))
                    delta := rand.Float64( ) − 0.2
                    p += delta
                    outrec.Set_price(p)
                    WriteOutput(&outrec)
                }
            }
            WriteOutput(nil)
}
$PHI$),
-- input
t.*
from ( select i::int from generate_series(1, 4) i ) t
) foo;
```

tsrun.sql—This query will process the data generated by load.sql and produce ascending and descending runs. Please note that this query will use a SQL OLAP Window function, row_number( ) over (partition by symbol order by day) to force a partition by stock symbol, order by trading day. Such constraints are important for the correctness and the efficiency of the transducer code.

```
-- Example of PHI Transducer.
-- The following SQL will produce run from stock data.
--
select
--
-- Output columns
--
dg_utils.transducer_column_text(1) as symbol,
dg_utils.transducer_column_int4(2) as d0,
dg_utils.transducer_column_float8(3) as p0,
dg_utils.transducer_column_int4(4) as d1,
dg_utils.transducer_column_float8(5) as p1,
--
-- Transducer functions, $PHI$ is PostgreSQL dollar quoted string.
--
dg_utils.transducer($PHI$PhiExec go
// BEGIN INPUT TYPES
// symbol string
// day int32
// price float64
// END INPUT TYPES
//
// BEGIN OUTPUT TYPES
// symbol string
// start int32
// startprice float64
// end int32
// endprice float64
// END OUTPUT TYPES
//
package main
func main( ) {
            var outrec *OutRecord
            for rec := NextInput( ); rec != nil; rec = NextInput( ) {
                symbol, _ := rec.Get_symbol( )
                day, _ := rec.Get_day( )
                price, _ := rec.Get_price( )
            if day == 0 {
                    if outrec != nil {
                        WriteOutput(outrec)
                    }
                    outrec = new(OutRecord)
                    outrec.Set_symbol(symbol)
                    outrec.Set_start(day)
                    outrec.Set_startprice(price)
                    outrec.Set_end(day)
                    outrec.Set_endprice(price)
                } else {
                    // Check if it is a run, either up or down.
                    isuprun := price >=
outrec.GetValue_endprice( ) &&
outrec.GetValue_endprice( ) >= outrec.GetValue_startprice( )
                    isdownrun := price <=
outrec.GetValue_endprice( ) &&
outrec.GetValue_endprice( ) <= outrec.GetValue_startprice( )
                    if isuprun || isdownrun {
                        outrec.Set_end(day)
                        outrec.Set_endprice(price)
                    } else {
                        oldrec := outrec
                        outrec = new(OutRecord)
                        outrec.Set_symbol(symbol)
                        outrec.Set_start(oldrec.GetValue_end( ))
                        outrec.Set_startprice(oldrec.
                        GetValue_endprice( ))
                        outrec.Set_end(day)
                        outrec.Set_endprice(price)
                        WriteOutput(oldrec)
                    }
                }
            }
            if outrec != nil {
                WriteOutput(outrec)
            }
            WriteOutput(nil)
}
$PHI$),
-- input. Note that the row_number( ) over (...) will force
a partition and ordering by day
-- on the inputdata to transducer. This is important, as the run building
in transducer assumes such partition
-- and ordering.
t.symbol, t.day, t.price
from (
            select row_number( ) over (partition by symbol order
by day), symbol, day, price from stock
) t
;
```

The two example queries above are difficult to express in SQL, and further, are difficult to efficiently execute in a relational database. For example, to generate simulated data and produce runs, knowledge is needed requiring the “history” of each of the stocks (e.g., the current state of the stock, as well as the last prior state of the stock). This can be implemented more easily using code written in a different programming language (e.g., Go).

### Second Example Application

An example application of a transducer with respect to a co-authorship database is described below.

The structure of graph data (sometimes referred to as “tree data”) can be stored in an RDBMS. In an example scheme, the graph can be encoded as an edge table, where each row of the tablet indicates an edge (from source to destination) in the graph. For example:

CREATE TABLE Edge (src int, dest int);

However, graph algorithm can be difficult to express in SQL (e.g., using relational algebra). Alternatively, many useful graph algorithms can be executed in parallel using a Bulk Sync Parallel (BSP) scheme. Thus, a BSP scheme can be implemented using a transducer, rather than through the use of SQL.

As example, it is difficult to execute a Bread First Search (BSF) in SQL. However, BSF can be more easily implemented in an imperative programming language using BSP. Example psuedo-code for such an process is included below:

```
SELECT Tr_outputs
            Tr_Code (‘
                // BSP BSF code (e.g., source code written in a
language other than SQL).
            ‘)
            Src, dest - this are inputs
            FROM EDGE
```

Example code to perform the functions above is included below.

dblp.sql—DBLP is the co-authorship graph for academic publications in the field of Computer Science. This query runs BFS (Breadth First Search) over this graph database. The algorithm use BSP (Bulk Synchronous Parallelism) to run the algorithm in parallel on all database nodes.

```
select
--
-- Output columns
--
dg_utils.transducer_column_int4(1) as dist,
dg_utils.transducer_column_int4(2) as cnt,
--
-- Transducer functions, $PHI$ is PostgreSQL dollar quoted string.
--
dg_utils.transducer($PHI$PhiExec go #SEGID# 0
//
// BEGIN INPUT TYPES
// a int32
// b int32
// END INPUT TYPES
//
// BEGIN BSP TYPES
// a int32
// b int32
// END BSP TYPES
//
// BEGIN OUTPUT TYPES
// a int32
// b int32
// END OUTPUT TYPES
//
package main
import (
            “log”
            “os”
            “strconv”
)
type node struct {
            flag int32
            edge [ ]int32
}
func do_x(id string, s string) {
            peers := [ ]string{“localhost:20000”, “localhost:20001”}
            myid, _ := strconv.Atoi(id)
            ss, _ := strconv.Atoi(s)
            src := int32(ss)
            // graph data structure.
            graph := make(map[int32]*node)
            // BSP init
            BspInit(peers, myid)
              //
            // superstep 1: redistribute edges according to src id
            // original input graph is (x, y) where x < y
            // but we double it and put (y, x) in as well.
              //
              // Note here, this is the ordinary PHI NextInput loop
              //
            for rec := NextInput( ); rec != nil; rec = NextInput( ) {
                var brec, brec2 BspRecord
                a, _ := rec.Get_a( )
                b, _ := rec.Get_b( )
                brec.Set_a(a)
                brec.Set_b(b)
                if a%2 == 0 {
                    BspSend(0, &brec)
                } else {
                    BspSend(1, &brec)
                }
                brec2.Set_a(b)
                brec2.Set_b(a)
                if b%2 == 0 {
                    BspSend(0, &brec2)
                } else {
                    BspSend(1, &brec2)
                }
            }
            BspSync(false)
              //
            // superstep 2: build graph. The graph is a
            map from node id to its out edges.
              // each node also has a flag, initialized to 0
              (meaning has not been visited).
              //
            log.Printf(“SuperStep 2: myid %d, build partial graph.”,
            myid)
            for brec := BspNext( ); brec != nil; brec = BspNext( ) {
                a, _ := brec.Get_a( )
                if a%2 != int32(myid) {
                    log.Fatalf(“Bug: node id %d sent to bsp worker
%d.”, a, myid)
                }
                b, _ := brec.Get_b( )
                if graph[a] != nil {
                    graph[a].edge = append(graph[a].edge, b)
                } else {
                n := new(node)
                    n.edge = [ ]int32{b}
                    graph[a] = n
                }
            }
            //
            // Start by sending dummy message to myself, this is the
            beginning point of
              // BSF.
              //
            if src%2 == int32(myid) {
                var brec BspRecord
                log.Printf(“SuperStep 2: myid %d. Sending out a rec to
start bsf, from node %d”, myid, src)
                brec.Set_a(src)
                BspSend(int32(myid), &brec)
            }
            BspSync(false)
            //
            // Now loop supersteps. This is the BSF proper. Basically,
we read input from
              // prev superstep, for each node we have not visisted
before, we mark the flag of
  // the node to a positive number.
  //
            sstep := int32(2)
            totalvisit := 0
            for {
                sstep++
                log.Printf(“StepStep %d: running bfs”, sstep)
                cnt := 0
                ocnt := 0
                firstvisit := 0
                for brec := BspNext( ); brec != nil; brec =
                BspNext( ) {
                    cnt++
                    visit, _ := brec.Get_a( )
                    if visit%2 != int32(myid) {
                        log.Fatalf(“Bug: node id %d sent to bsp
worker %d.”, visit, myid)
                    }
                    node := graph[visit]
                    if node != nil {
                        if node.flag == 0 {
                            firstvisit++
                            node.flag = sstep − 2
                            for _, dst := range node.edge {
                                ocnt++
                                var orec BspRecord
                                orec. Set_a(dst)
                                BspSend(dst%2, &orec)
                            }
                        }
                    } else {
                        log.Fatalf(“Invalid node id %d”, visit)
                    }
                }
                totalvisit += firstvisit
                log.Printf(“Superstep %d, myid %d: recv %d,
first time visit %d, totalvisit %d, and output %d.”, sstep,
myid, cnt, firstvisit, totalvisit, ocnt)
                sync := BspSync(cnt == 0)
                if sync < 0 {
                    log.Printf(“Superstep %d sync done!”, myid)
                    break
                }
            }
            // Output, we will output the number of nodes
            that is connect to src
            nodeCnt := make(map[int32]int32)
            for _, node := range graph {
                if node.flag > 0 {
                    oldcnt := nodeCnt[node.flag]
                    nodeCnt[node.flag] = oldcnt + 1
                } else {
                    oldcnt := nodeCnt[−1]
                    nodeCnt[−1] = oldcnt + 1
                }
            }
            for k, v := range nodeCnt {
                var outrec OutRecord
                outrec.Set_a(int32(k))
                outrec.Set_b(int32(v))
                WriteOutput(&outrec)
            }
            WriteOutput(nil)
}
func main( ) {
            do_x(os.Args[1], os.Args[2])
}
$PHI$), i, j
from (select i, j from dblp) tmpt
;
```

The example query above is difficult to express in SQL, and further, is difficult to efficiently execute in a relational database. For example, the graph query data is recursive in nature. Writing a recursive SQL query is difficult with respect to graph data. For instance, if the graph is a tree, with no cycles, it may be possible to develop a SQL query, but it would be difficult. With cycles, it may be prohibitive difficult, and potentially dangerous, as the RDBMS be incapable of handling cycles correctly and hang the system. This can be implemented more easily using code written in a different programming language (e.g., Go).

Although various examples are described herein, it is understood that these are illustrative examples. In practice, other implementations are also possible. Further, although various examples are described with respect to SQL, it is understood that this is an illustrative example. In practice, other programming languages (e.g., Query By Example (QBE) and Pig Latin, among others) also can be used in conjunction with a transducer.

### Example Technical Benefits

The implementation described herein can provide various technical benefits. For example, as described herein, a transducer can improve the capabilities of the RDBMS and/or enhance the performance of the RBDMS. In some cases, a transducer can be used to parse, interpret, and execute code or programs written in any number of different languages. In some cases, a transducer can be used to parse, interpret, and execute just in time (JIT) code compiled code for improved performance.

As described herein, to utilize a transducer, code can be developed combining syntactically correct SQL with functions specific to the transducer (e.g., user-defined functions, such as functions specifying code to parsed, interpreted, and executed by the transducer, functions specifying the inputs and outputs of the transducer code, and so forth). This can be beneficial, as it enables a user to develop code using the same client-side tools that he might otherwise be using to develop SQL code exclusively. For example, a user can develop transducer code using the same Java Database Connectivity (JDBC) applications, command line tools, graphical user interfaces, and/or other tools that he would normally use for developing SQL code.

As described herein, a transducer can be used to embed transducer logical nodes (e.g., corresponding to code written in an imperative programming language) in a relational physical execution plan. Further, in some cases, transducer logical nodes and logical nodes representing relational operations can communicate (e.g., exchange inputs/outputs) via one or more sequences of rows. In some cases, the rows can be typed. For example, the data type of the fields of each row can be inferred, and the transducer code can be typed checked. Typed rows and type checking can provide various benefits. For example, in SQL, data is typically typed. Therefore, typed rows enable transducer logical nodes to connect with “classical” logical nodes representing relational operations (e.g., to read inputs from a SQL-based subquery, to send outputs to another SQL-based operation, and so forth). Further, if the transducer code is a strong typed language (e.g., for example Java, Go, and C++), type information may be needed to compile the code. In some cases, this type information can also be used to generate machine code (e.g., JIT code) to further improve performance.

In some cases, communications between transducer logical nodes and nodes presenting relational operators can be under flow control. For example, under flow control, the communications pipeline between each of the nodes can be regulated, such that only a specific or constant amount of memory is consumed. This is beneficial, for example, as it reduces the likelihood of memory starvation or “deadlock” due to a lack of available resources. In some cases, the use of a transducer can result in a fully bounded buffer size (e.g., locked to a specific size) and an elimination of deadlocks entirely.

In some cases, an RDBS can process data in parallel using “shared nothing” architecture. A transducer can configured such that it respects the data parallelism of the RDBMS. For example, when data is partitioned, the transducer can run in parallel on different nodes.

In some cases, transducer code may require data to be partitioned in a particular way, and the input to transducer may be required to be in certain order. All these can be enforced by developing SQL code that uses SQL's partition by, order by clause. Physical execution constraints (e.g., partitioning constraints, ordering constraints, etc.), can be specified in a SQL subquery and respected by the transducer.

For example, a user can use the following SQL code to partition data into different nodes for execution:

SELECT Transducer_Outputs, Transducer(‘code’),
Trasducer_input.* from
( select row_number over partition by (col1, col2) order by (col3) from
T)
Transducer_Input

The bold fonts use a SQL window function to enforce data partition by (col1, col2) and by each partition, and rows are fed to transducer ordered by col3. Partitioning and ordering are performed by highly optimized RDBMS operators before data is fed to transducer.

Further, a transducer can be tightly integrated with an SQL optimization module. Further, during query planning and optimization, a transducer can read the statistics of its input sequence, deduce the statistics of its output sequence (e.g., the cardinality of outputs, histograms, the most frequent values, etc.). Deduced stats can be feed into an RDBMS optimization module to pick the optimal plan for further processing. Thus, the ordering constraints specified in SQL code can be carried into the transducer code, and can be used to guarantee both correctness (e.g., as the transducer code assumes order or partition), and efficiency (e.g., as the transducer knows order and partition information, and therefore can use more efficient algorithms or processes to execution its operations).

The use of a transducer can be particularly beneficial in certain circumstances. For example, relational algebra operations (e.g., as used in declarative programming languages, such as SQL), cannot express recursive queries. Further, in some cases, the syntax to perform certain functions (e.g., the SQL extension syntax) may be somewhat clumsy, inefficient, and/or unsafe. However, a recursive query often can be implemented using a procedural imperative programming language (e.g., Python). Thus, a transducer can enable the selective use of non-SQL code in certain contexts to improve the functionality and/or efficiency of the system.

In some cases, a transducer enables the use of a bulk synchronous parallel (BSP) programming model, which can be used for processing graph data. In some cases, the transducer enables certain BSP-specific algorithms to be used with respect to data stored in an RDBMS, such as “Breadth First Search,” “Shortest Path,” and “Page Rank.”

Further, a transducer can be data integration tool, for example to extract data outside of RDBMS and join, aggregate, with data inside RDBMS. Such tasks might be difficult or resource prohibitive to perform using only commands of a declarative programming languages.

Further, a transducer can be used to implement various time series algorithm and streaming data algorithm. Such tasks also might be difficult or resource prohibitive to perform using only commands of a declarative programming languages.

### Example Systems

Some implementations of subject matter and operations described in this specification can be implemented in digital electronic circuitry, or in computer software, firmware, or hardware, including the structures disclosed in this specification and their structural equivalents, or in combinations of one or more of them. For example, in some implementations, the system 100 can be implemented using digital electronic circuitry, or in computer software, firmware, or hardware, or in combinations of one or more of them. In another example, the process 200 can be implemented using digital electronic circuitry, or in computer software, firmware, or hardware, or in combinations of one or more of them.

Some implementations described in this specification can be implemented as one or more groups or modules of digital electronic circuitry, computer software, firmware, or hardware, or in combinations of one or more of them. Although different modules can be used, each module need not be distinct, and multiple modules can be implemented on the same digital electronic circuitry, computer software, firmware, or hardware, or combination thereof.

Some implementations described in this specification can be implemented as one or more computer programs, i.e., one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD-ROM and DVD-ROM disks. The processor and the memory can be supplemented by, or incorporated in, special purpose logic circuitry.

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

A computer system may include a single computing device, or multiple computers that operate in proximity or generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise by virtue of computer programs running on the respective computers and having a client-server relationship to each other.

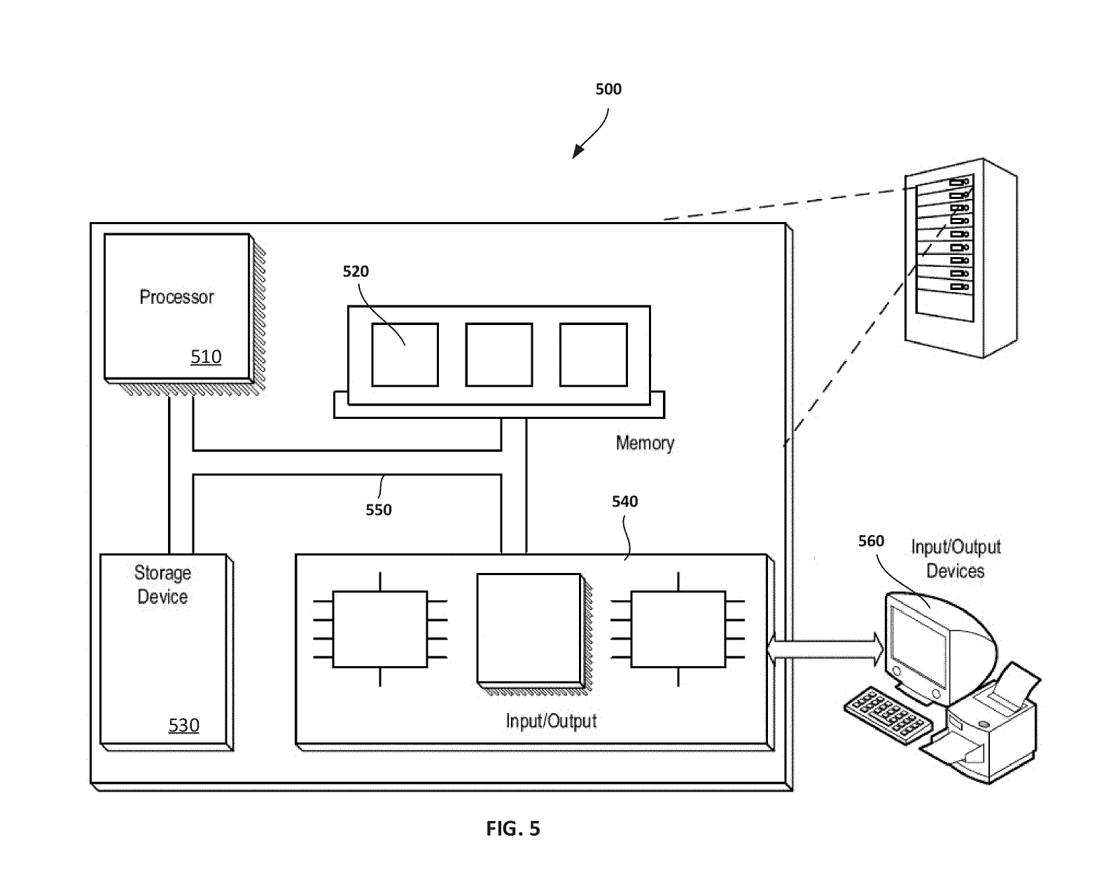

FIG. 5 shows an example computer system 500 that includes a processor 510, a memory 520, a storage device 530 and an input/output device 540. Each of the components 510, 520, 530 and 540 can be interconnected, for example, by a system bus 550. The processor 510 is capable of processing instructions for execution within the system 500. In some implementations, the processor 510 is a single-threaded processor, a multi-threaded processor, or another type of processor. The processor 510 is capable of processing instructions stored in the memory 520 or on the storage device 530. The memory 520 and the storage device 530 can store information within the system 500.

The input/output device 540 provides input/output operations for the system 500. In some implementations, the input/output device 540 can include one or more of a network interface device, e.g., an Ethernet card, a serial communication device, e.g., an RS-232 port, and/or a wireless interface device, e.g., an 802.11 card, a 3G wireless modem, a 4G wireless modem, a 5G wireless modem, etc. In some implementations, the input/output device can include driver devices configured to receive input data and send output data to other input/output devices, e.g., keyboard, printer and display devices 560. In some implementations, mobile computing devices, mobile communication devices, and other devices can be used.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

A number of embodiments have been described. Nevertheless, it will be understood that various modifications may be made without departing from the spirit and scope of the invention. Accordingly, other embodiments are within the scope of the following claims.

What is claimed is:

1. A method comprising:
receiving, at a computer system, a query for data stored in a relational database management system, the query comprising one or more first functions of a first programming language, and one or more second functions specifying computer code of a second programming language different from the first programming language;
generating, using the computer system, a logical query plan based on the query, wherein generating the logical query plan comprises:
generating one or more first logical nodes corresponding to the one or more first functions, the one or more first logical nodes representing relational operators defined by the one or more first functions;
generating one or more second logical nodes corresponding to the one or more second functions, the one or more second logical nodes representing operations defined by the computer code of a second programming language; and
generating the logical query plan comprising a logical tree representing the query, the logical tree including the one or more first logical nodes interconnected with the one more second logical nodes, wherein each interconnection represents an exchange of intermediate data between nodes;
generating, using the computer system, a physical execution plan based on the logical query plan; and
executing the physical execution plan to retrieve the data stored in the relational database management system.

2. The method of claim 1, wherein the first programming language is a declarative programming language.

3. The method of claim 2, wherein the first programming language is Structured Query Language (SQL).

4. The method of claim 1, wherein the second programming language is an imperative programming language.

5. The method of claim 4, wherein the second programming language is one of C, C++, Java, Scala, Python, Perl, Go, R, Lisp, or F#.

6. The method of claim 1, wherein each second function comprises:
a code sub-function specifying the computer code of the second programming language;
an input sub-function specifying input data for the computer code of the second programming language; and
an output sub-function specifying output data resulting from an execution of the computer code with respect to the input data.

7. The method of claim 6, wherein generating the logical query plan further comprises:
generating a plurality of candidate logical trees representing the query,
selecting one of the plurality of candidate logical trees based on one or more optimization criteria, and
including the selected candidate logical tree in the logical query plan.

8. The method of claim 7, wherein the one or more optimization criteria comprise at least one of:
a data size of the data stored in the relational database management system,
an arrangement of the data stored in the relational database management system, or
an estimated resource cost associated with retrieving the data stored in the relational database management system.

9. The method of claim 7, wherein the one or more optimization criteria comprise an estimated resource cost associated with executing the computer code of the second programming language.

10. A non-transitory computer-readable medium including one or more sequences of instructions which, when executed by one or more processors, causes:
receiving, at a computer system, a query for data stored in a relational database management system, the query comprising one or more first functions of a first programming language, and one or more second functions specifying computer code of a second programming language different from the first programming language;
generating, using the computer system, a logical query plan based on the query, wherein generating the logical query plan comprises:
generating one or more first logical nodes corresponding to the one or more first functions, the one or more first logical nodes representing relational operators defined by the one or more first functions;
generating one or more second logical nodes corresponding to the one or more second functions, the one or more second logical nodes representing operations defined by the computer code of a second programming language; and
generating the logical query plan comprising a logical tree representing the query, the logical tree including the one or more first logical nodes interconnected with the one more second logical nodes, wherein each interconnection represents an exchange of intermediate data between nodes;
generating, using the computer system, a physical execution plan based on the logical query plan; and
executing the physical execution plan to retrieve the data stored in the relational database management system.

11. The non-transitory computer-readable medium of claim 10, wherein the first programming language is a declarative programming language.

12. The non-transitory computer-readable medium of claim 11, wherein the first programming language is Structured Query Language (SQL).

13. The non-transitory computer-readable medium of claim 10, wherein the second programming language is an imperative programming language.

14. The non-transitory computer-readable medium of claim 13, wherein the second programming language is one of C, C++, Java, Scala, Python, Perl, Go, R, Lisp, or F#.

15. The non-transitory computer-readable medium of claim 10, wherein each second function comprises:
a code sub-function specifying the computer code of the second programming language;
an input sub-function specifying input data for the computer code of the second programming language; and
an output sub-function specifying output data resulting from an execution of the computer code with respect to the input data.

16. The non-transitory computer-readable medium of claim 15, wherein generating the logical query plan further comprises:
generating a plurality of candidate logical trees representing the query,
selecting one of the plurality of candidate logical trees based on one or more optimization criteria, and
including the selected candidate logical tree in the logical query plan.

17. The non-transitory computer-readable medium of claim 16, wherein the one or more optimization criteria comprise at least one of:
a data size of the data stored in the relational database management system,
an arrangement of the data stored in the relational database management system, or
an estimated resource cost associated with retrieving the data stored in the relational database management system.

18. The non-transitory computer-readable medium of claim 16, wherein the one or more optimization criteria comprise an estimated resource cost associated with executing the computer code of the second programming language.

19. A system comprising:
one or more processors; and
a non-transitory computer-readable medium including one or more sequences of instructions which, when executed by the one or more processors, causes:
receiving, at a computer system, a query for data stored in a relational database management system, the query comprising one or more first functions of a first programming language, and one or more second functions specifying computer code of a second programming language different from the first programming language;
generating, using the computer system, a logical query plan based on the query, wherein generating the logical query plan comprises:
generating one or more first logical nodes corresponding to the one or more first functions, the one or more first logical nodes representing relational operators defined by the one or more first functions;
generating one or more second logical nodes corresponding to the one or more second functions, the one or more second logical nodes representing operations defined by the computer code of a second programming language; and
generating the logical query plan comprising a logical tree representing the query, the logical tree including the one or more first logical nodes interconnected with the one more second logical nodes, wherein each interconnection represents an exchange of intermediate data between nodes;
generating, using the computer system, a physical execution plan based on the logical query plan; and
executing the physical execution plan to retrieve the data stored in the relational database management system.

20. The system of claim 19, wherein the first programming language is a declarative programming language.

21. The system of claim 20, wherein the first programming language is Structured Query Language (SQL).

22. The system of claim 18, wherein the second programming language is an imperative programming language.

23. The system of claim 22, wherein the second programming language is one of C, C++, Java, Scala, Python, Perl, Go, R, Lisp, or F#.

24. The system of claim 19, wherein each second function comprises:
a code sub-function specifying the computer code of the second programming language;
an input sub-function specifying input data for the computer code of the second programming language; and
an output sub-function specifying output data resulting from an execution of the computer code with respect to the input data.

25. The system of claim 24, wherein generating the logical query plan further comprises:
generating a plurality of candidate logical trees representing the query,
selecting one of the plurality of candidate logical trees based on one or more optimization criteria, and
including the selected candidate logical tree in the logical query plan.

26. The system of claim 25, wherein the one or more optimization criteria comprise at least one of:
a data size of the data stored in the relational database management system,
an arrangement of the data stored in the relational database management system, or
an estimated resource cost associated with retrieving the data stored in the relational database management system.

27. The system of claim 25, wherein the one or more optimization criteria comprise an estimated resource cost associated with executing the computer code of the second programming language.
